(19) United States
(12) Patent Application Publication
(10) Pub. No.: US 2013/0344458 A1
(43) Pub. Date: Dec. 26, 2013

(54) Process for securing a dental implant and dental implant

(71) Applicant: Mohamad Saeed Taha, Luran Alexandria (EG)

(72) Inventor: Mohamad Saeed Taha, Luran Alexandria (EG)

(21) Appl. No.: 14/004,711

(22) PCT Filed: May 9, 2011
(86) PCT No.: PCT/NO11/00149

§ 371 Date: Sep. 13, 2013

(51) Int. Cl. A61C 8/00

(52) U.S. Cl. CPC A61C 8/0024; A61C 8/0068; A61C 8/0089
USPC 433/174

(57) ABSTRACT

The present invention concerns a method for inserting a dental implant into the jawbone as a replacement for a tooth, said jawbone comprising cortical bone matter surrounding a core of spongy bone, wherein a hole is excavated in the cortical bone of the upper surface of the jawbone using an excavation tool, said hole penetrating mainly the cortical bone matter of the jawbone. The excavation tool is then removed and a threaded implant is placed in the excavated hole of the upper surface of the jawbone; the threaded implant is forwarded into the spongy bone core of the jawbone without any prior drilling having been done into the spongy bone section of the jawbone; and the implant is left in the spongy bone core of the jawbone for promoting integration of the implant with the surrounding bone (Osteointegration). The invention also concerns a dental implant suitable for being used in the method, said dental implant comprising an osseoimplant (Osseous part) part (1) forming a screw with threads (2) and a core (3), said osseoimplant part (Osseous part) (1) also including a head section (7) forming a securing part for an abutment (6) or representing the abutment (6).

### 1) TECHNICAL FIELD

The present invention concerns a new and improved method for inserting a dental implant into the upper or lower jawbone as a replacement for a tooth in need of repair. The relevant method according to the present invention comprises the steps defined in the included set of claims. The present invention also concerns a dental implant with the features specified in the included set of claims. Such an implant is especially suited to be used in the method according to the invention.

More specifically the method for inserting a dental implant into the jawbone as a replacement for a tooth wherein said jawbone comprising cortical bone matter surrounding a core of spongy bone, said method comprising the following steps:

a: excavating a hole in the cortical bone of the upper surface of the jawbone using an excavation tool, said hole penetrating mainly the cortical bone matter of the jawbone;

b: removing said excavation tool and placing a threaded implant in the excavated hole of the upper surface of the jawbone;

c: forwarding said threaded implant into the spongy bone core of the jawbone without any prior drilling having been done into the spongy bone section of the jawbone;

d: leaving said implant in the spongy bone core of the jawbone for promoting integration of the implant with the surrounding bone (Osteointegration).

The dental field of oral implantology (dental implants) represents the part of oral science used to replace a missing tooth or teeth in the oral cavity by inserting a fixture (implant) in the bone which is capable of receiving an aesthetic crown or prosthesis after a healing period and which mimics the natural teeth in appearance and function.

### 2) PRIOR ART/EXPLANATION OF FIGURES

The figures of the present patent application include:

In FIG. 0 showing the general anatomy of the jawbone is depicted.

FIG. 1 shows the jawbone to be manipulated with the soft tissue in the process of being retracted;

FIG. 2 shows the process of drilling through the upper cortical bone of the jawbone with a suitable drill;

FIG. 3 shows the location of the tools (implant driver and dental implant according to one embodiment of the invention) immediately prior to the insertion of the implant;

FIG. 4 shows a dental implant according to one embodiment of the invention in the process of be implanted into the spongy bone of the jawbone;

FIG. 5 shows a dental implant according to one embodiment of the invention securely inserted into the spongy bone of the jawbone;

FIG. 6a shows an assembly of an implant according to an embodiment of the present invention with a secured abutment on top of the implant screw part; and

FIG. 6b shows the assembly of FIG. 6a in a sectional view along the section plane A-A in FIG. 6a;

FIG. 7 shows an exploded view of the implant parts of the implant according to an embodiment of the present invention;

FIG. 8a shows the section of the embodiment of the implant to be screwed into the jawbone;

FIG. 8b shows the section of FIG. 8a in a cross-sectional sectional view of the screw part;

FIG. 8c shows the hexagonal head of the implant section shown in FIG. 8a; and

FIG. 8d shows a longitudinally sectional view of the screw part going into the jawbone of an embodiment of the implant according to the present invention.

FIG. 9 shows an example of the structure of the jawbone with an illustrated location of an implant tool.

It is relevant to pass through the bone anatomy to explain the difference between the developed technique and the prior art.

In FIG. 0 the general anatomy of the jawbone is depicted. As is shown in FIG. 0, depicting a cross-section of the bone, the jawbone is formed of two different layers indicated as A and B. The layers A and B have the following constitution and structure:

A) Cortical bone: This is the first layer of bone present under the soft tissue (gums) and it is dense to a degree in which no manual force can penetrate it and using drills is the only way used to approach it for the insertion of dental implants.

B) Spongy bone: This is the second layer of bone and it is located underneath the cortical plate of bone A. It is of poorer quality in relation to physical hardness and also in quantity than the first layer A, and layer B is the layer of bone that receives the implant. This layer of bone is approached by drilling as well as the conventional technique states.

When inserting dental implants or generally mending teeth, it is also prudent to consider if the relevant tooth is located in the upper or lower arch of the mouth. The teeth are located either in the upper line of teeth or the lower line. The set of bone and teeth is called Arch and they are represented as upper and lower arches. Each arch is divided into 2 halves: anterior half or poster half (front group of teeth and back group of teeth).

In the general anatomy of the jawbone there also are present structures such as the soft tissue (gums) abutting the surface of the teeth and forming a partial sheath around the teeth protecting the sensitive lower part of the teeth from external irritations or stimuli (heat, cold, acids, etc.). The teeth are also associated with nerves giving sensations to the individual about the forces, Alveolar Nerve of the mandibular canal present in the lower arch teeth. The soft tissue is located over the jawbone, and a hole reaching down to the jawbone is created when a tooth is extracted. In the method according to the present invention, in such a hole a dental implant structured according to the invention is placed as a replacement for the natural extracted tooth. Alternatively there may exist a situation where the tooth to be replaced has been missing for a period of time allowing bone and soft tissue to fill the hole of the missing tooth or alternatively to perform what is known as bone remodeling which takes 4-8 weeks as an average time. In such instances an incision is made over the crest of the site where the implant is to be placed forming a “flap” of soft tissue. Normally the “flap” is retracted to allow access to the underlying jawbone. Alternatively “flapless” surgery where a piece of mucosa is punched out (manually or by a rotary punch) from the implant site may be performed.

In the jaw the bone structure is divided into strata lying below the soft tissue (gums). This is illustrated in FIG. 9. In FIG. 9 the image shows the soft tissue 1 retracted (or removed) followed by the cortical plate of bone A (the thin film in which contains no holes or black areas) then a thick layer of spongy bone B (which has spaces or darker areas) then another thin film of bone which represents another cortical plate A′ of bone lining the maxillary sinus C (the sinus is the space or chamber adjacent the bone of the cortical plate A′. In FIG. 9 the soft tissue 1 is retracted (or removed) followed by the cortical plate A of bone (the thin film in which contains no holes or black areas) then a thick layer of spongy bone B (which has spaces or darker areas) then another thin film of bone which represents another cortical plate A′ of bone lining the maxillary sinus C (the sinus is the space or chamber above the bone).

Again , the bone available in that image between the soft tissue and the sinus is divided into 3 layers of bone: cortical A—soft B—cotrical A′.

Unnecessary damage to or penetration of the cortical substructure A′ and the maxillary sinus C is undesired when manipulating the relevant teeth since this may cause undue discomfort to the patient and may be potentially harmful by creating an opportunity for bacterial attack or other complications.

When considering placing an implant into the jawbone as a replacement for a tooth, the type of bone forming the tooth will have to be considered. There exist several degrees of bone hardness D1-D5. The hardness classification is D1: >1250 Hounsfield units, D2: 850-1250 Hounsfield units, D3: 350-850 Hounsfield units, D4: 150-350 Hounsfield units, D5: <150 Hounsfield units. The tactile sense of such bone firmness categories may be illustrated by when drilling and placing implants into D1 bone this is similar to drilling into oak or maple wood, D2 bone is similar to the tactile sensation of drilling into white pine or spruce, D3 bone is similar to drilling into balsa wood, D4 bone is similar to drilling into Styrofoam, while D5 gives an even softer tactile sensation.

According to prior art techniques the placement of an implant that is to become osseointegrated requires a preparation into the bone using either hand osteotomes or precision drills with highly regulated speed to prevent burning or pressure necrosis of the bone. After a variable amount of time to allow the bone to grow onto and between the threads of the surface of the implant (osseointegration), a fixed—such as crown or bridges—or removable prosthesis is placed onto the implant. The amount of time required to place an implant will vary depending on the experience of the practitioner and difficulty of the individual situation.

When placing a dental implant prior to the present invention in an edentulous (without teeth) jaw sites, a pilot hole was bored into the recipient bone, taking care to avoid the vital structures, in particular the inferior alveolar nerve (IAN) and the mental foramen within the mandible. Drilling into jawbone was performed in several separate steps. A pilot hole was initially drilled (a pilot drill was used to create an initial hole) and subsequently expanded by using progressively wider is drills (typically between three and seven successive drilling steps, depending on implant width and length). Care had to be taken not to damage the osteoblast or bone cells by overheating. For instance a cooling saline spray was introduced to keep the temperature of the bone below 47° C. The implant screw used might be self-tapping or threads might be fitted in the bone, and an implant was screwed into place at a precise torque so as not to overload the surrounding bone (overloaded bone may die, a condition called osteonecrosis, which may lead to failure of the implant to fully integrate or bond with the jawbone). Typically in most implant systems, the osteotomy or drilled hole was about 1 mm larger in all dimensions to create an undersized space in which the implant size is larger than this undersized hole to allow friction and better stability than the implant being placed, due to the shape of the drill outline. This because if a tapered implant is to be obtained a tapered drill should, and if a parallel sided implant is to be placed, a parallel sided drill should be used, and so on. Care had to be taken as to the added length when drilling in the vicinity of vital structures.

As explained supra and as is well known in the field of oral implantology, inserting an implant into the bone of the jaw requires the use of a number of drills (according to the manufacturer instructions) being inserted in both layers A and B to create an undersized hole or ‘an implant bed having the same outline of the implant’ which allows the implant to be inserted with a certain amount of ‘Primary Stability’ in the bone. The primary stability allows the implant to be in direct intimate contact with the bone to facilitate bridging the gap between the bone and the implant with natural newly formed bone created by the ‘Osteoblasts Cells’ and to form what is known as the ‘Osteointegration period’ which is a critical factor for the success of dental implants.

After the Osteointegration is achieved, an ‘abutment’ is connected on the top of the implant in order to receive a prosthesis which resembles the appearance and the color of the natural teeth.

### Prior Art

There exist a number of implants and implantation techniques in the prior art. Thus it is known from U.S. Pat. No. 7,108,511 B1 (Todd E. Shatkin) a dental implant of a self-threading type including a dental crown wherein the dental crown is secured directly onto the protruding section of the implant. This patent also discloses a method for attaching a prosthetic crown to the jawbone of a patient, where there initially is drilled a starter hole with a diameter of less than 1,6 mm and depth of approximately 4-8 mm through an implant stint hole in a surgical stint guide and into the jawbone, and where a self-tapping threaded dental implant of about 1.6 to 2.5 mm is screwed into the starter hole.

Furthermore, it is known from U.S. Pat. No. 6,368,108 B1 (William M. Locante and Robert L. Riley) a method for placing a temporary dental implant into the jawbone of a patient, wherein there is drilled a cylindrical hole into the jawbone and wherein the bore of the hole is tapped and a dental implant is driven into the bore. The patent discloses a method wherein a healing cap initially is placed onto the dental implant core, and where said healing cap is removed prior to the final placement of the artificial tooth onto the exposed implant.

Also from U.S. Pat. No. 5,312,255 (Ernst Bauer) and U.S. Pat. No. 7,281,924 B2 (James T. Ellison) there are known different types of dental screw implants.

From the previous explanation of the prior art of the dental implantology, the use of drills is a must and drilling is to be done in both layers of bone, preferably by a torque controlled motor.

The disadvantages inherent in the prior art techniques for inserting dental implants is the inability to monitor the exact location and penetration of drills into the bone tissue, its inability to notice impending damage of jawbone structures such as the maxillary sinus or the inferior alveolar nerve, as well as the need for drilling into the spongy bone for inserting a prior art dental implant.

Thus there is a need for an improved method for safe and secure introduction of dental implants ensuring an improved control of the progression of the implantation process, as well as improved implants to be used in such methods.

Definition of Terms:

In the context of the present disclosure the term “tooth” represents a tooth in both the lower and upper arch of the oral cavity, and includes both non-damaged or damaged teeth. The relevant tooth may be healthy or may include caries attack or other types of damage (e.g. due to acid attack from beverages or traumatic damage due to impacts).

In the context of the present disclosure the term “about” or “mainly” or “substantially” means a margin of error of ±10% of the relevant number or interval (unless otherwise specified in the disclosure).

In the context of the present disclosure the term “upper” with reference to a tooth, means the surface of the tooth furthest removed from the roots of the tooth.

In the context of the present invention the term “jawbone” relates to the bone of both the upper and lower arch of the oral cavity.

In the context of the present disclosure the used terms have the meaning as understood by the average skilled person within the dental field.

Explanation of the Present Invention.

The implantation method according to the present invention will be explained infra.

### 3) THE DEVELOPED TECHNIQUE ACCORDING TO THE INVENTION

The technique according to the present invention succeeds the removal of a tooth exposing the tooth hole progressing down to the jawbone through the soft tissue (gums) 1.

The soft tissue (gum) 1 covering the bone (A,B) should in one embodiment of the method according to the invention be reflected using any conventional surgical technique (surgical flaps having any proper design) or non surgical techniques such as rotary and hand (manual) soft tissue punches (FIG. 1). Reflecting the soft tissue may be facilitated by placing a suitable reflecting tool in the hole formerly occupied by the extracted tooth or part of a tooth.

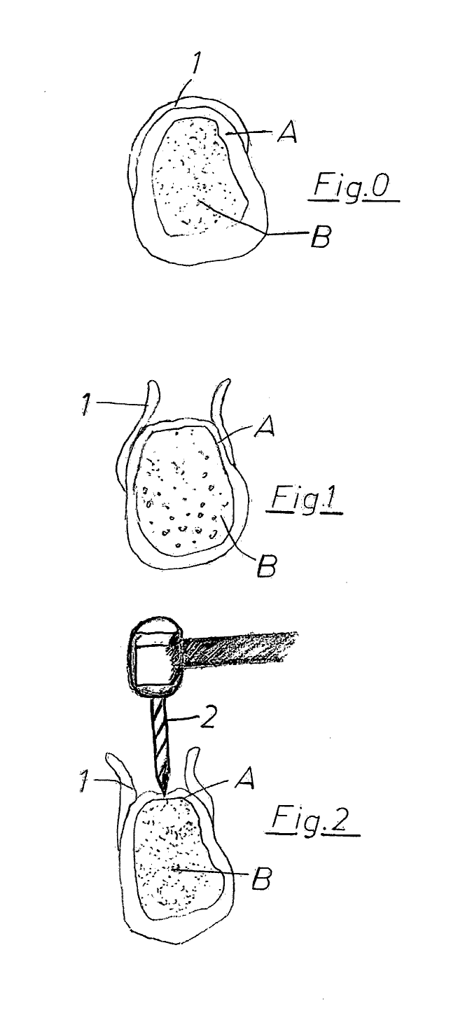

After the soft tissue 1 is reflected (FIG. 1) and an adequate access is available to reach the underlying bone (A,B), a drill 2 is used to create an opening in the cortical plate of bone (A) only (without further drilling in the spongy layer (B)) (FIG. 2). Any conventional dental drill can be used to create this step in which it should be having an adequate size (adequate diameter to facilitate the entrance of the implant in the remaining spongy bone). Normal diameters of such holes relate to the diameter of the relevant tooth, and will usually lie within the interval 0.5 mm to 5 mm, more preferred within 0.5 to 3 mm, even more preferred 1 mm to 2 mm, e.g. 1, 1.5, 2, 2.5 or 3 mm. Determination of the actual size of the hole lies within the competence of the skilled practitioner. The drill can be made of any material used within the art of dentistry, e.g. metal (steel, a metal alloy, diamond, etc.) and it can be disposable or reusable. The drill should be used with adequate cooling to avoid over heating of the bone. Normally a water-cooled drill is adequate, and a water-cooled supersonic drill is preferred. A torque controlled motor should be used to avoid bone resorption and damage to the bone.

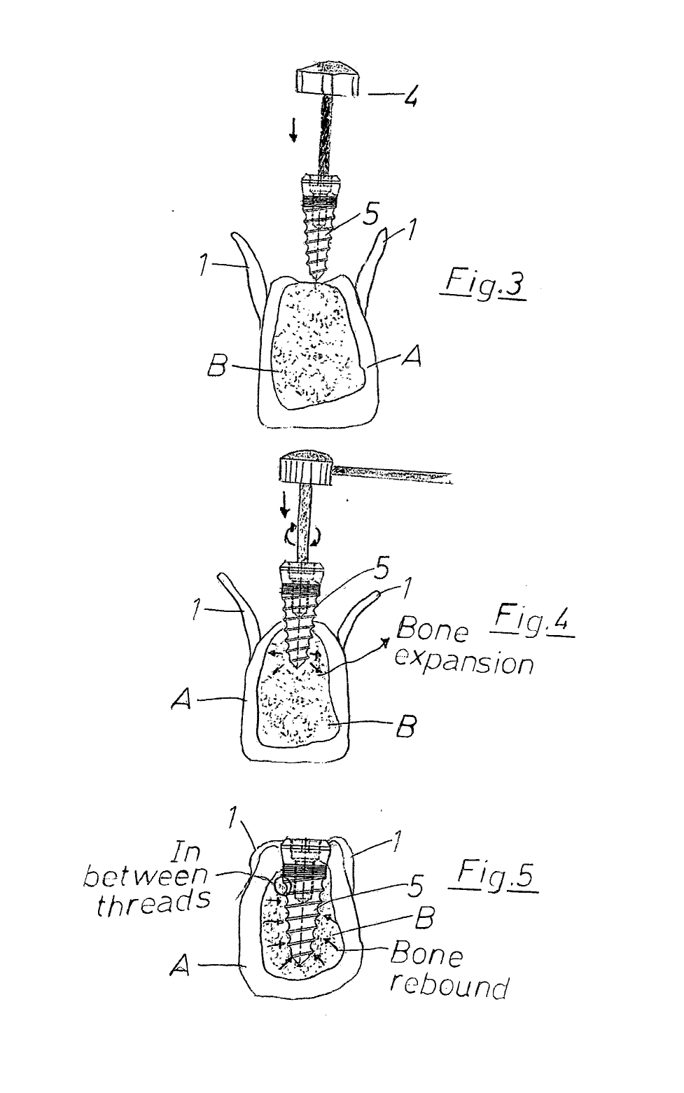

After the cortical bone (A) is penetrated, an implant 5 according to the invention is inserted preferably by tapping in the underlying spongy bone (B) with a little force to allow some ‘gripping action’ through its tip in which it will help the threads of the implant to facilitate the tapping/rotation/screwing of the implant inwards into the spongy bone (B) of the tooth (FIG. 3). The insertion of the implant 5 should preferably be done with a holder (implant driver 4) that allows better control of the implant during insertion and better force application. As long as the implant 5 is going deeper in the spongy bone B using hand forces, the procedure should be completed using manual control since manual rotation/insertion of the implant according to the invention indicates to the dentist whether or not the bone is soft enough to be treated with such a technique. A torque force applied to the implant exceeding 60 to 65 NCM will indicate that the bone tissue is too hard/firm to continue the manual insertion process according to the invention.

The design (e.g. the length, the total diameter, the thread angle and depth of the threads of the implant inserted into the spongy bone, the stem diameter of the implant, the cone angle of the implant stem, etc.) of the implant 5 depends on the ‘Bone Expansion and Compression Phenomena’ (FIG. 4) to go deeper until it reaches the preferred position in the bone decided by the dentist. Determination of the extent of the “Bone Expansion and Compression Phenomena” lies within the competence of the skilled practitioner and represents one aspect of the state of the art.

In one embodiment of the invention the implant design allows it to penetrate the spongy bone B with the least resistance since it has a small tip and unique threads designed to make the implant self tapping as well as expansion and compression of spongy bone easy and fast. Features associated with an implant suitable for performing the implantation method according to the invention, as explained supra, will be disclosed in the following sections.

The manual technique according to the present invention is preferably confined to D3 and D4 bone types since they contain more amounts of spongy bone and it is normally not applied in D1 or D2 bone types which are mainly formed of hard (cortical) bone in which manual forces are almost impossible to penetrate.

Generally the softer the bone the more of the implant will go inwards using the implant holder or driver. The harder the bone the sooner a wrench or a ratchet will be used to complete the insertion of the implant in the resisting bone.

Since the spongy bone has a certain modulus of elasticity (depends on its location in each jaw and other systematic factors, said factors being known to the person skilled in the art), the expansion and compression phenomena will vary: the more the elasticity the more bone expansion will occur the faster and easier the implant will go deeper and the less ratchet and wrenches are used. The amount of spongy bone available to the method according to the present invention may be indicated by the torque necessary to drive the relevant implant into the spongy bone after penetrating the leading hole drilled through the cortical bone, and the torque applied according to the present invention should not exceed 65 NCM, and should preferably lie within the interval 50 to 60 NCM.

On account of the expansion of the spongy bone when driving/screwing the dental implant according to the present invention into the jawbone, it is preferred in one embodiment of the invention to allow some time to pass during the insertion to allow the spongiosa of the jawbone to relocate within the bone structure so as not to stress the cells of the spongiosa unduly. A normal time interval for driving the implant according to the present invention into the spongy bone of the jaw will lie within (5 minutes up to one hour, more preferred 10-50 minutes, even more preferred 15-30 minutes, although shorter or longer intervals also may be applied according to the considerations and judgment of the dentist or surgeon performing the procedure according to the present invention). After the removal of the soft tissue (which should not be time counted in the technique), normally the technique according to the present invention should not pass 10 minutes.

The technique according to the present invention depends on this phenomenon in which the Spongiosa surrounding the implant will be compressed to leave enough room or space for the implant as it goes deeper. The compression of the bone will be followed by a slight rebounding process (FIG. 5) depending on the elasticity of the bone in which it will create much better primary stability which is the first step in gaining success in dental implants. The better primary stability the shorter the distance needed for the Osteoblasts to travel and bridge the gap between implant and bone, thus building new bone in a shorter period of time:less time for the Osteointegration to be obtained.

The space between the threads of the implant will allow the rebounded bone to go “in between” the threads (FIG. 5) which creates a better primary stability (rebounded bone between the threads does not occur in the conventional way) and faster Osteointegration (drilling or cutting the bone will create no rebounding process of spongy bone—no compression forces are created in the first place that may lead to rebounding of the soft spongy bone of the jawbone—and conventional methods will lead to less primary stability and longer Osteointegration periods.

The “Quality of Osteointegration” using the technique according to the present invention represents a highly improved process compared to the prior art processes. In the method according to the present invention a larger surface area of the implant is in direct intimate contact with the bone and even available between the threads of the implant thus the larger amount of cells is available at the implant bone interface and the stronger the bone being connected to the implant and the higher torque rates needed to affect the implant. Such implants can withstand higher mastication forces because it has a higher quality of integration than the one obtained from the conventional technique which leads to a higher resistance to the falling damaging forces that may lead to bone resorption in a certain area surrounding the implant because higher amount of bone is surrounding it with a higher quality in which—in worst scenario—a longer survival rate when compared to an implant being placed using the drilling technique when both are subjected to the same conditions and same amount of forces with the same direction (in a state of comparison).

The depth to which the implant is to screwed is determined by f.ex. pre operative xray pictures. For example the dentist may have an xray for the place that requires an implant and from the dentist's knowledge it is decided that 12 mm is good as it will not damage any thing at the bottom (but the dentist should go to the maximum possible to increase the surface area and to get good osseointegration of the implant. The depth may be determined by vision. It is possible to make a post operative xray for clarification of the exact position of the bone).

The depth of the relevant implant is also determined by its location in the upper or lower jaw, and the largest possible length should be used. Normal lengths of the implant lie within the interval 10-16 mm, e.g. 8 mm depending on the available depth.

The implant process according to the present invention can be used as a one stage implant process with a higher success rate and much less risk because higher primary stability is gained. The technique according to the present invention will provide a higher resistance to micro motion in one stage implants in which there is a high torque level obtained and more resistance will be available. Still all efforts should be observed to provide protection to the implant as much as possible from the patient and the practitioner.

Two stages technique may also be applied using the method of direct insertion of the implant into the spongy bone of the jawbone according to the present invention providing the advantage of a shorter waiting period from the patient for Osteointegration to be achieved. The shorter waiting period obtained in the implantation technique according to the present invention makes the implant idea much more tolerated and accepted by both the patient and the dentist/surgeon.

The method according to the present invention is performed with anesthesia. If an anesthetic is used, this may be of a local or systemic variety.

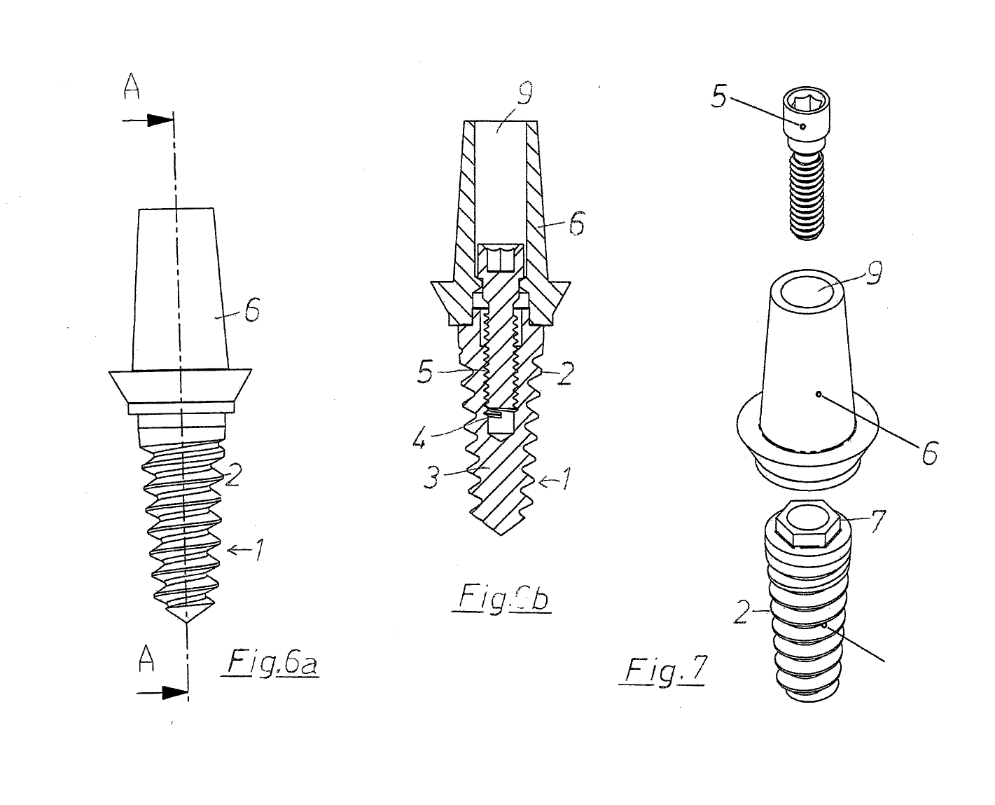

In the following section of the disclosure of the present invention an example of an embodiment of a dental implant according to the invention will be presented. Said embodiment of a dental implant according to the invention is depicted in FIGS. 6-8.

### 4 SPECIFICATIONS AND FEATURES

A) Implant Features:

The implant according to the present invention can be manufactured from any orally and pharmaceutically acceptable material (such as Titanium or Zirconium or be a ceramic or composite material or any other materials and alloys) that is compatible with the bone and provides resistance and adequate function for the patient receiving it. Selecting a suitable material for the relevant dental implant (taking into account the evaluations presented supra concerning the location of the implant, the mastication load the tooth and implant will be subjected to, the possible support from other teeth in the vicinity of the implant, the type of bone where the implant is to be inserted, etc.) lies within the capacity of the person skilled in the art based on the present disclosure.

The implant according to the present invention may have any suitable diameter and any suitable length determined by the dentist/surgeon skilled in art. Normally, however, the dental implant according to the present invention will normally have a diameter within the interval 2.8 mm to 4.75 mm although larger diameters also may be used. Generally the largest possible diameter is used. Generally, the thinner and shorter implants will have less resistance when inserted in the spongy bone and the selection of the implant size highly depends on the quality and quantity of bone, especially the spongy bone of the jaw.

The implant according to the present invention will be accounted for in the sections infra. In these sections the implant according to the invention will be explained with reference to the FIGS. 6a-b, 7 and 8a-d representing an embodiment of an implant according to the invention especially adapted to be used in the method according to the invention.

An implant according to the present invention comprises an osseous part of the implant or section 1. The osseous part of the implant 1 is the part to be screwed into the spongy bone of the jaw, and it comprises external threads 2. The external threads 2 may be of a self-tapping type or may be of a non-self-tapping type (depending on the size (diameter/length) of the implant, the amount of spongy bone the implant is to be inserted into, the quality of the bone, the depth and angle of the threads, etc.). The number of threads 2 around the stem section 3 of the implant part may also exceed 1, and may be double or triple helixed, although one thread 2 spiraling around the implant stem 3 is preferred. In one embodiment the type of thread 2 around the stem 3 of the implant 1 according to the present invention is an isometric 1 mm thread.

The depth of the threads 2 of the implant part 1 will normally lie in the interval 10-50% of the total diameter of the implant, where the rest of the diameter of the implant represents the stem 3 of the implant. The depth of the threads 2 will provide an anchoring of the implant into which the spongy bone may rebound or grow. The depth of the threads 2 will, however, weaken the stem 3 by providing a thinner stem 3 depending on the depth of the treads 2. Since the stem 3 will give the implant part 1 its rigidity, integrity and strength, it will normally represent 50-90% of the total diameter of the implant 1. This will normally give a thread depth to diameter of the stem ratio in the interval 1:1 to 1:9. However, other thread depth to stem diameter ratios may also be used, depending on the circumstances (e.g. the nature of the spongy bone, drill hole diameter (through the cortical bone plate), depth of the cortical bone plate, etc.). Determination of thread depth to stem diameter ratios may be selected by the person skilled in the art.

When referring to the stem part 3 of the implant 1 according to the present invention, this relates to the part of the implant not being the threads or the head, notwithstanding whether or not the stem part 3 may be solid or hollow.

In the embodiment of the implant 1 according to the invention shown in FIG. 6-8, the stem part 3 going into the spongy bone is shown to be solid (with the exception in on embodiment of an optional internal tread 4 receiving a retaining bolt 5 for securing an abutment section 6 to the implant section 1). However, the stem section may also be equipped with an internal penetrating or partly penetrating hole (not shown) provided to receive some of the spongy bone excavated when the implant is crewed into the jawbone. Such a penetrating or partly penetrating hole may be axially aligned in the stem section of the implant part 1, and may coincide with the internal hole 4 for the retaining bolt 5 (if present).

Alternatively, in one embodiment the external threads 2 of the implant part 1 may include helixed grooves for receiving the excavated spongy bone material (not shown). This embodiment may be relevant when the implant part 1 is equipped with self-tapping bone-excavating threads and has a solid stem 3.

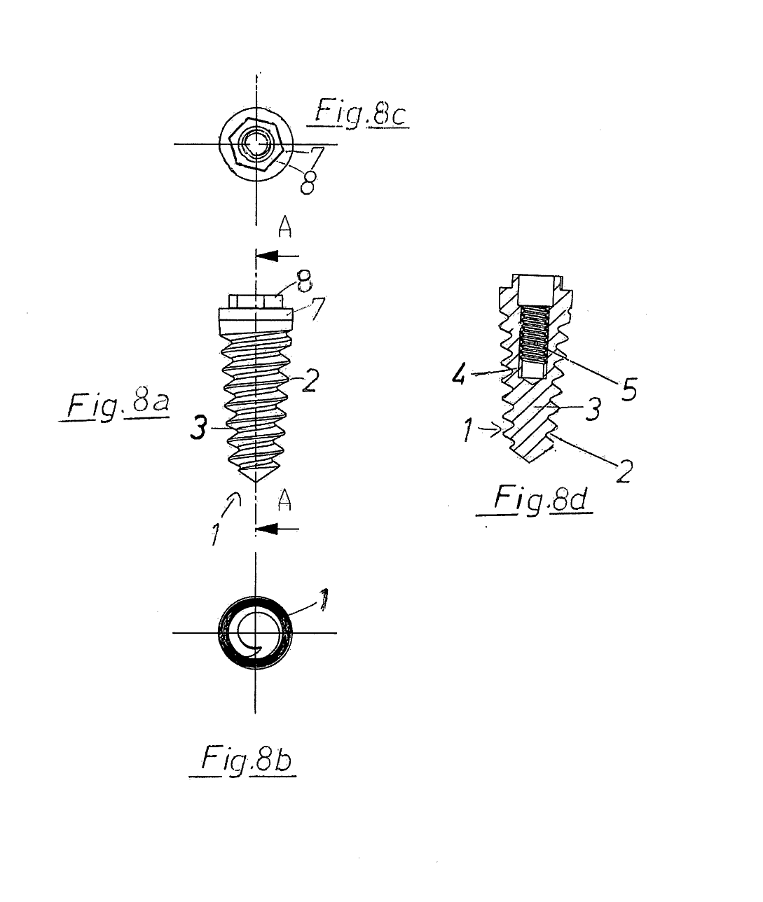

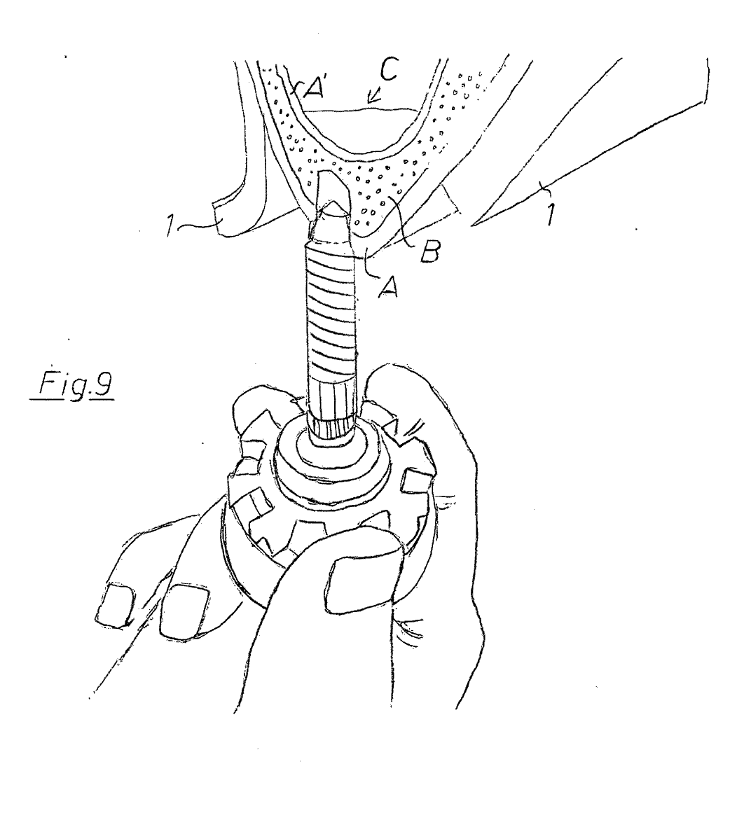

The implant according to the present invention may have a thread and/or stem that is cylindrical (with one size of the diameter along the length of the implant axis) or it may alternatively be coned with the lesser diameter of the cone facing towards the end of the implant farthest away from the abutment 6 (corresponding to the end of the implant protruding from the jawbone) (see FIG. 8d).

The coning of the implant may ease the insertion of the implant into the spongy bone. If a coning of the implant 1 is used, a cone angle within the interval more than zero degrees and up to 10° may be appropriate, more preferred 0.5-9°, even more preferred 1-8°, e.g. 5, 6, 7 or 8°.

The implant 1 according to the present invention may also include a head section 7. is The head section 7 preferably comprises a device 8 for securing an insertion tool to the implant. Examples of such devices are nuts (hexagonal, square or other types with internal and/or external securing sections), screws (with linear or star-shaped securing sections). Alternatively the head section 7 may include a hole or aperture for securing a drill for screwing the implant into the jawbone (see FIG. 8d). Said hole or aperture may in one embodiment coincide or be identical with the internal hole 4 for the retaining screw 5. All threaded holes may have right-hand or left-hand threads depending on their intended use. Thus, in one embodiment, the external threads 2 of the implant may be right-handed whilst the internal threads of the hole 4 for the retaining bolt 5 may be left-handed while a hexed head 8 is present on the head section 7 (cemented, cast or otherwise secured to the head section of the implant). In such an embodiment the hole 4 opens through the head 8. The head 8 is in this embodiment used for screwing the implant right-handed into the jawbone by using the hexed head 8.

In one embodiment the abutment 6 may be present as a separate part. In another embodiment the abutment 6 may be integrated with the implant. The abutment 6 may be secured to the implant 1 in any convenient manner, e.g. by cementing the abutment 6 to the head section 7 of the implant 1. Another way of securing the abutment 6 to the implant 1 is by using a retaining bolt 5 to be screwed into the internal hole 4 of the implant part 1 (see FIG. 6b).

The implant 1 and abutment 6 can be one piece which is used for immediate loading or they can be separated in which the abutment 6 will be placed in later stages when Osteointegration is achieved. The one piece implant will highly improve the immediate loading line of treatment since it offers higher levels of primary stability (the most important factor in immediate loading).

In cases of one piece implants, a special screw is used to screw the implant inwards to the desired and proper position. In such an embodiment the abutment 6 is equipped with an internal female hole 9. A tool fits in this embodiment the female portion 9 of the top of the abutment and can be connected with a wrench or a ratchet. The female part 9 can be hexed or having any design that allows the forces to be transferred properly to the one piece implants and provides interlocking.

B) Connection Type Features:

The implant 1 can have any type of connection with the abutment 6 such as internal hex, external hex or even cemented and screw typed abutments or any design maintains the relationship properly with the implant.

C) Cover Screw Features:

During the osseointegration and healing period it is of essence that the implant is not subjected to excessive load forces. It is thus normal to cover the implant with a temporal cover screw (not shown) both for protecting the implant and for avoiding excessive load during this critical period. Any cover screw can be used to cover the implant and protect it during the healing period. It can be manufactured from any compatible material and it can have any size (within the accepted range) and it can have any height (although not a height making the temporal cover screw protruding above the gum with more than few mm only, and preferably making the cover screw lying marginally above the gum line).

Cover screws that can act as healing abutments in the same time are also compatible.

D) Abutment Features:

The abutment 6 itself can have any design or size (within the accepted range depending on the available space, see supra) since it is not directly related to the technique according to the present invention. The material of the abutment 6 used can be made of any material that provides an adequate strength and provides the right function. Selecting a suitable material for the abutment 6 lies within the competence of the person skilled in the art, and examples of such materials are ceramics, metals or metal alloys (titanium or zirconium or steel, composite materials, plastics, gold etc.).

As mentioned earlier, the abutment can be manufactured as one piece together with the implant or can be provided separately.

E) The Implant's Tip Features:

The technique according to the present invention is safer whenever there are maxillary sinus approximation cases since there are no drills being used which can perforate the cortical layer of bone underlying the maxillary sinus leading to serious complications (if the Schneiderian membrane is torn). The soft bone technique according to the present invention and the manual forces will not penetrate the cortical plate of bone underlying the sinus which leads to a more safer technique than he ones previously used for this purpose, and the technique according to the present invention gives an indication that the cortical plate of bone is reached as the resistance will highly increase (to a degree in which the implant cannot be inserted more by any means) indicating the maximum length of the available spongy bone. This small indication is considered very essential as it will save the patient from complications that may affect the quality of life for the patient and the dentist from failure.

This situation is not available in the normal technique since drills are capable of drilling the cortical plate of bone easily and with almost no alerts whenever an important anatomical structure is approximated. Drills give no indications or hints since they are rotary but the technique does since it is manual and more tactile.

F) Retaining Screw Features:

Any retaining screw 5 can be used whenever the connection type with the abutment requires. It can have any length, any diameter and any thread design. It should provide continuous connecting between implant and abutment as long it is being placed. Any degree of torque can be used to apply on the retaining screw but the recommended torque is 32 NCM.

G) Healing Abutment Features:

Any healing abutment 6 can be used having any height or diameter (within the accepted range, see supra) with the implant to provide soft tissue healing.

H) Impression Technique Features:

Any impression technique can be done with the abutment 6 selected to complete the prosthetic stage. Any implant analogs and abutment analogs can be compatible and used with that implant design.

Again, any abutment made from any material can be used with any impression technique to build any prosthesis or any crown made of any materials that provides strength and function, are compatible with that technique.

To complete the dental procedure according to the present invention a tooth prosthesis (not shown) will be secured to the abutment 6 of the implant according to the present invention. Such a tooth prosthesis is made according to techniques and methods known to the person skilled in the art, but as an non-limiting example it may be mentioned that the relevant tooth prosthesis should be matched to the adjacent teeth by way of design and color. The material of such tooth prosthesis is also known to the person skilled in the art, and suitable materials may be metal (e.g. gold or gold alloys), ceramics or composite materials. The tooth prosthesis will include an internal hole fitting the external shape of the abutment 6.

The soft bone technique according o the present invention is important in cases where there is reduced quantity and quality of bone. It will save the available small amount of bone since it needs no drilling in the spongy bone which is the layer of bone that receives the full size of the implant.

Avoiding the use of drills will save the bone from any heat generation that is susceptible to occur whenever there is inappropriate cooling at the drill-bone contact or interface which is considered an important advantage.

When more disadvantages such as bone drilling and the accompanied susceptible heat are eliminated, a better amount and environment can be available for the Osteoblasts to build more bone and bridge the gap between the implant and the surrounding bone which is the main target and desire whenever a dental implant is placed.

Bone Expansion and Compression Phenomena:

The Upper Arch:

The technique according to the present invention is safer than the conventional way whenever used in the maxillary arch since it will not penetrate the cortical plate of bone underlying the maxillary sinus.

Lower Arch:

As mentioned before, the spongy bone receiving the implant will be compressed to allow the implant to go downwards in which the spongy bone available at the sides will be compressed laterally and the spongy bone available downwards will be compressed inferiorly.

From this base, implants being inserted in the lower posterior region (with low quality and quantity of bone) having a certain amount of bone resorption will give an indication that mandibular canal hosting the Inferior Alveolar Nerve is about the be damaged as more compression leads to more pressure on the canal which occurs only if the implant is getting closer to the canal.

As the patient will feel more pressure on the canal and nerve, more pain will be generated (in cases of infiltration technique of anesthesia is used), during which the wrench causes more forces. Such high irritation will be decreased by short time as the pressure will be relieved due to the rebounding phenomena mentioned above.

Such pain might be considered as a bless in the technique according to the present invention as it indicates the actual position of the implant in relation to the canal and preserves some options to the patient and dentist which may not be available in the conventional way where direct damage can occur to the canal and nerve whenever misjudgment of the correct length of the implant and it's set of drills happens.

The technique according to the present invention gives important hints and/or alerts before the maxillary sinus and/or the Inferior Alveolar Nerve are about to be damaged in a way or another which is not present in the prior art.

The technique according to the present invention increases the success rates of cases used to face more failure rates due to poor quality and quantity of bone.

The technique according to the present invention is easy, safer than the previously known tooth implantation techniques and saves time for the patient during the procedure itself and throughout the whole period of treatment as osteointegration is achieved much faster than previously possible.

The technique according to the present invention allows more tactile sensation to be felt by the dentist since it is mostly manual which allows the dentist to understand and feel the quantity and quality of bone in a better way than the conventional technique.

1-9. (canceled)

10. A dental implant suitable for being used in a manual method for inserting a dental implant into the jawbone as a replacement for a tooth,
characterized in that said dental implant comprises an osseoimplant (Osseous part) part (1) forming a tapered screw with a pointed lead end and with self-tapping threads (2) for penetration into the spongy bone of a tooth when manually entered into untreated spongy bone of a tooth providing a surface facing the spongy bone forming an area of expansion and compression of the spongy bone, said implant also comprising a core (3), said osseoimplant part (Osseous part) (1) also including a head section (7) forming a securing part for an abutment (6) or representing the abutment (6),
said dental implant being particularly adapted for securing a dental implant through a method comprising:
a: excavating a hole in the cortical bone of the upper surface of the jawbone using an excavation tool, said hole penetrating mainly the cortical bone matter of the jawbone;
b: removing said excavation tool and manually placing a threaded implant comprising an osseoimplant (Osseous part) part (1) forming a tapered screw with a pointed lead end and with self-tapping threads (2) for penetration into the spongy bone of a tooth when manually entered into untreated spongy bone of a tooth providing a surface facing the spongy bone forming an area of expansion and compression of the spongy bone, said implant also comprising a core (3), said osseoimplant part (Osseous part) (1) also including a head section (7) forming a securing part for an abutment (6) or representing the abutment (6), in the excavated hole of the upper surface of the jawbone;
c: forwarding said threaded implant manually into the spongy bone core of the jawbone without any prior drilling having been done into the spongy bone section of the jawbone;
d: leaving said implant in the spongy bone core of the jawbone for promoting integration of the implant with the surrounding bone (Osteointegration).

11. The dental implant according to claim 10, wherein the core of the Osseous part (1) includes an internal hole (4) for harboring a screw or retaining bolt (5) located for securing the abutment (6) to the Osseous part (1)

12. The dental implant according to claim 11, wherein said abutment (6) includes an axial hole (9) for harboring the retaining bolt (5).
